(19) United States
(12) Patent Application Publication
(10) Pub. No.: US 2008/0137479 A1
(43) Pub. Date: Jun. 12, 2008

(54) Method for interpreting seismic data using a digitizing display tablet

(76) Inventors: Oyvind Syljuasen, Oslo (NO); Jostein Lima, Oslo (NO); Even Oscar Andersen, Oslo (NO)

Correspondence Address: E. Eugene Thigpen;Petroleum Geo-Services, Inc., P.O. Box 42805, Houston, TX, 77242-2805, US

(21) Appl. No.: 11/583,435

(22) Filed: Oct. 19, 2006

(51) Int. Cl. G01V 1/00

(52) U.S. Cl. 367/72

(57) ABSTRACT

A method for interpreting seismic data includes displaying seismic data on a graphic digitizing tablet. At least one data point is entered into a seismic data interpretation program by contacting a write end of a digitizing stylus to the digitizing tablet at a user-selected position within the displayed seismic data.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of computerized interpretation of seismic data. More specifically, the invention relates to methods for interpreting seismic data that use a digitizing display tablet for operator input.

2. Background Art

Seismic surveying is used to evaluate structures of, compositions of, and fluid content of subsurface earth formations. A particular application for seismic surveying is to infer the presence of useful materials, such as petroleum, in the subsurface earth formations. Generally, seismic surveying includes deploying an array of seismic sensors at or near the earth's surface, and deploying a seismic energy source near the sensors also at or near the surface. The seismic energy source is actuated and seismic energy emanates from the source, traveling generally downwardly through the subsurface until it reaches one or more acoustic impedance boundaries. Seismic energy is reflected from the one or more impedance boundaries, where it then travels upwardly until being detected by one or more of the sensors. Structure and composition of the subsurface is inferred from the travel time of the seismic energy, and the amplitude and other attributes of the detected seismic energy.

Various computer programs are known in the art for interpreting seismic data and generating visual representations of the interpretations. Such visual representations may be printed on paper, but are more commonly made on a computer display such as a cathode ray tube, projector or liquid crystal display. Seismic data interpretation computer programs known in the art include those described, for example, in U.S. Pat. No. 5,432,751 issued to Hildebrand, and U.S. Pat. No. 5,153,858 issued to Hildebrand. Such seismic data interpretation programs display the seismic data in a manner which facilitates user input of interpretive information, such as selecting what the user perceives to be a feature in the seismic data corresponding to an acoustic impedance boundary in the subsurface, or other subsurface feature of interest. Such features of interest may be observed in displayed portions of the seismic data. Some seismic interpretation computer programs use interpretive input provided by the user to initialize automatic selection of correlative features in other portions of the seismic data. Still other interpretation programs provide for user input of visually interpreted features.

In such seismic interpretation computer programs, the program user provides the interpretive input to the computer using a mouse or similar graphic-based input device. The computer display is necessarily in two dimensions, however typical three dimensional (“3D”) seismic interpretation programs include functionality that enables perspective viewing of the data in three dimensions on the computer display, and the interpretative user input may be made in three dimensions. The interpretive information that is input by the user, typically x, y and z coordinates of selected points within the displayed volume of seismic data, is calculated by the program in response to the position of a display cursor. The x and y coordinates usually represent the equivalent geodetic position of the seismic data, and z may be travel time of the seismic energy that gave rise to the data or the depth in the earth's subsurface, depending on the type of data display and the particular interpretation program. The position of the display cursor is changed by movement of the mouse or other graphic input device. As the mouse is moved, the position of the cursor changes correspondingly. The equivalent spatial position of the cursor within the volume of seismic data displayed by the interpretation program is calculated depending on the perspective presented on the computer display. The user may select individual points in space for data entry by operating the control button on the mouse. Alternatively or additionally, some interpretation programs provide for input of a “string” of data points by having the user hold the control button on the mouse, and moving the mouse along a visually interpreted horizon or feature. Such string may represent the user's visual interpretation of a continuous “horizon” in the seismic data. A horizon typically corresponds to a stratigraphically continuous feature in the earth's subsurface, such as a boundary between subsurface formations having different mineral compositions.

While effective as a device to input data to an interpretation program, a mouse or similar graphic device can be difficult to use, and such use may be inaccurate, because movement of the mouse by the user is only indirectly related to movement of the cursor position. As explained above, the cursor position is related to the coordinate location of the data input to the interpretation program. The user must carefully control motion of the mouse such that the input data correspond most closely with the interpretive input the user desires to enter into the interpretation program.

What is needed is a system that provides a user of a seismic data interpretation program with a more precise, easier to operate interpretive input device.

### SUMMARY OF THE INVENTION

A method for interpreting seismic data according to one aspect of the invention includes displaying seismic data on a graphic digitizing tablet. At least one data point is entered into a seismic data interpretation program by contacting a write end of a digitizing stylus to the digitizing tablet at a user-selected position within the displayed seismic data.

Other aspects and advantages of the invention will be apparent from the following description and the appended claims.

### BRIEF DESCRIPTION OF THE DRAWINGS

FIG. 1 shows a portion of a hypothetical three-dimensional seismic data volume in order to explain the three-dimensional relationships described herein.

FIG. 2 is an isometric view of a portion of five seismic traces which shows the relationship between a “seed point” and its expression in four adjacent traces.

FIG. 3 illustrates an automatic tracking method of seismic data interpretation.

FIG. 4 illustrates an iterative automatic tracking method of seismic interpretation.

FIG. 5A is an overall architectural diagram of a digitizing display system.

FIG. 5B shows an entire computer system for interpreting seismic data using a method according to the invention.

FIG. 6A is a side view of an example stylus which includes a pressure-sensing mechanism in both ends thereof for detecting the pressure applied by the stylus to the surface of a digitizing display tablet.

FIG. 6B is a more detailed view of the erase end of the stylus.

### DETAILED DESCRIPTION

The description which follows includes an example of a seismic data processing program that accepts user input from a computer graphic user interface as part of the data processing and display. The interpretation program described herein is only one example of a program according to the invention. It is only necessary for purposes of this invention to have a computer seismic data processing program that accepts user input from a graphic user interface.

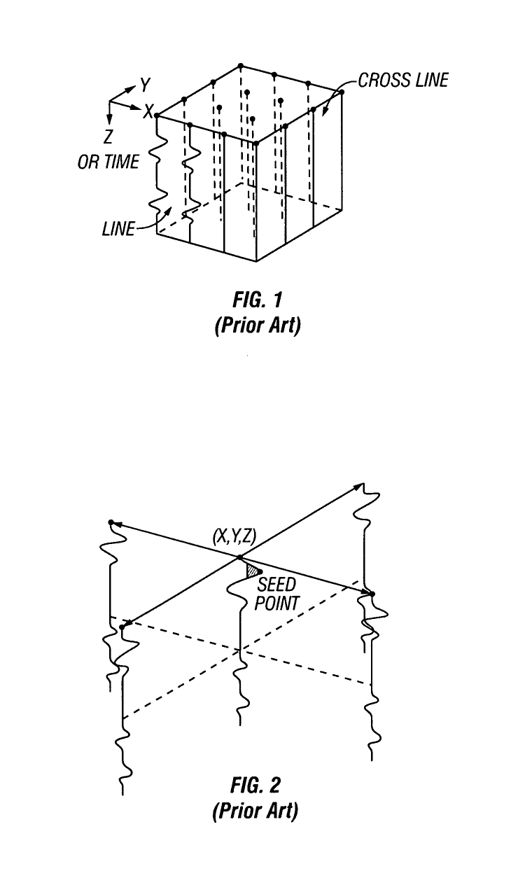

FIG. 1 is a perspective view of a portion of a three-dimensional (“3D”) seismic data volume entered into an example seismic data interpretation program. The vertical lines represent seismic traces, which are typically displayed with respect to two-way seismic signal travel time along the z-axis of the displayed seismic data volume. The small circles at the top of the volume represent the surface location of the seismic signals represented by the individual traces. The two-way travel time is related to the distance or depth into the earth and the velocity of the seismic signal within the formations in the earth's subsurface. Time is typically indexed with respect to the time at which the seismic energy source is actuated. Each individual trace is displayed in the form of amplitude with respect to time.

In interpreting seismic data as shown in FIG. 1, it is known in the art to generate various sections of the displayed data. A horizontal section or “time slice” is a horizontal (with respect to time) slice or plane drawn by the computer program through the volume of seismic data. Horizontal in the present context means that the plane is drawn through each trace at the same time (or depth if the displays is made with respect to depth on the z axis). A time slice represents the amplitude of all the traces in the seismic data volume at a common time. It is also known in the art to generate a map of an acoustic boundary surface, referred to as a “horizon”, by plotting a selected attribute of the seismic data traces. Mapping a horizon is similar to generating a topographic map. The selected attribute may be illustrated by various visual indicators such as unique colors or line contours, for example.

In one computerized system for tracking a horizon through a 3D volume of seismic data, the user selects at least one “seed point” having a particular seismic data attribute, which the computer program then uses to find a corresponding attribute in the other traces in a defined 3D seismic data volume in all directions within the 3D data volume as illustrated in FIG. 2, until the program reaches the boundaries of the defined 3D volume.

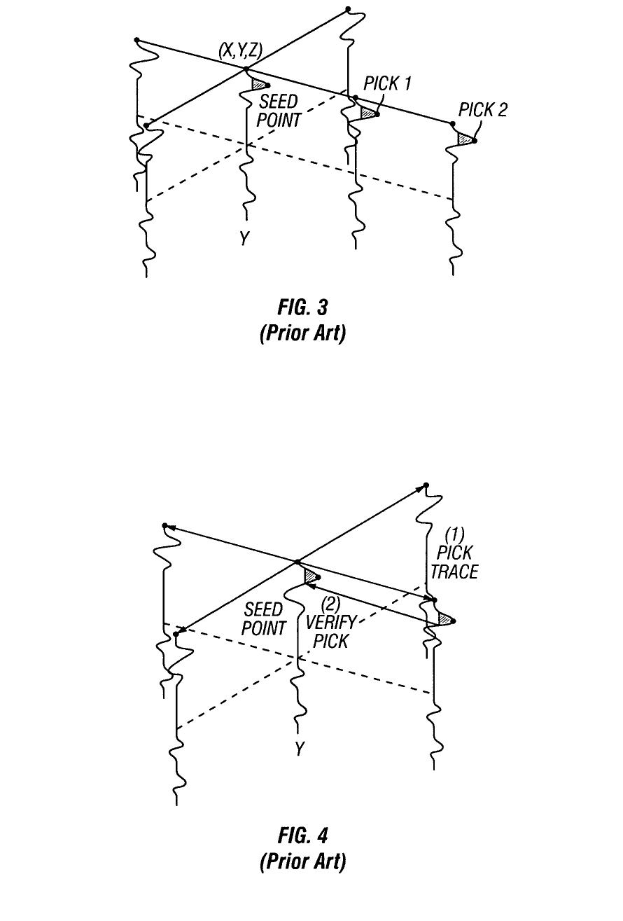

A “seed point” is specified by an x and y coordinate location and a time or depth (i.e., the z-axis of FIG. 1). It is also specified by a characteristic of the seismic signal at the seed point. Such characteristic is typically an amplitude maximum in the seismic data. Other characteristics, such as minimum amplitude, phase, frequency, etc., of the seismic data may be used. As shown in FIG. 3, a computer program using non-iterative picking then searched the seismic traces adjacent the trace having the seed point for similar amplitude values, picked the best one, then proceeded to the next available trace.

If an iterative picking computer program is used as the seismic data interpretation program, the computer verifies a pick in an adjacent trace by cross-referencing the previous trace. Verification means that if the amplitude of the picked trace is within the limits of tolerance set by the user, the pick is accepted. The user may specify the degree of similarity in amplitude (or other attribute) that is considered acceptable. If a pick does not pass such acceptance test, it can remain unused in the interpretation until at least one directly adjacent trace matched sufficiently to accept it. Once verified, the adjacent trace is treated as a new seed point and the picking from adjacent traces proceeds. FIG. 4 illustrates such iterative picking.

In other computer implemented seismic data interpretation programs, the user may be required to input additional interpretive data beyond merely picking one or more seed points. Such additional interpretive data input may include visual selection of horizons along one or more traces of seismic data.

As explained in the Background section herein, prior art seismic data processing programs accept user input from a graphic user interface device, such as a touch pad, a mouse, or a track ball. The actual data entered into the computer program depends on the position of a cursor within the displayed area defined by the computer display. Cursor position is controlled by the user input device. Because there is only indirect correspondence between the cursor position and movement of the user input device, data entry using such devices can be difficult for the user and may be inaccurate.

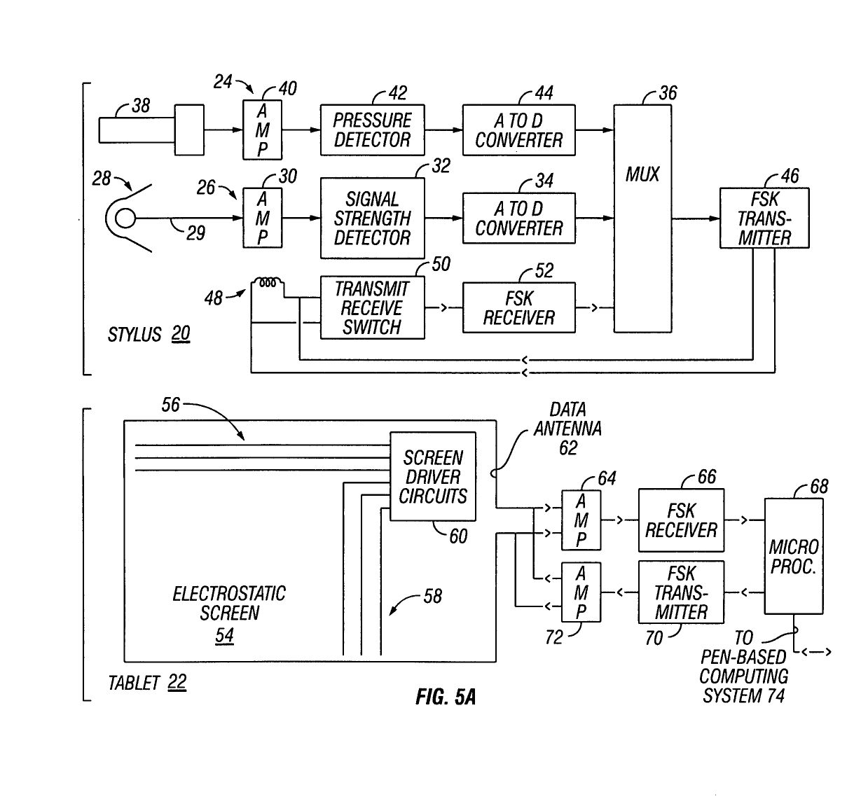

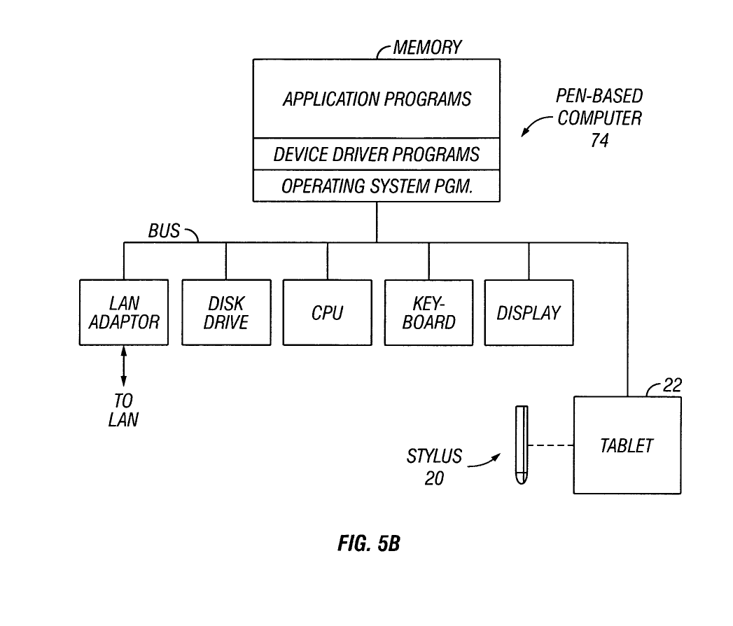

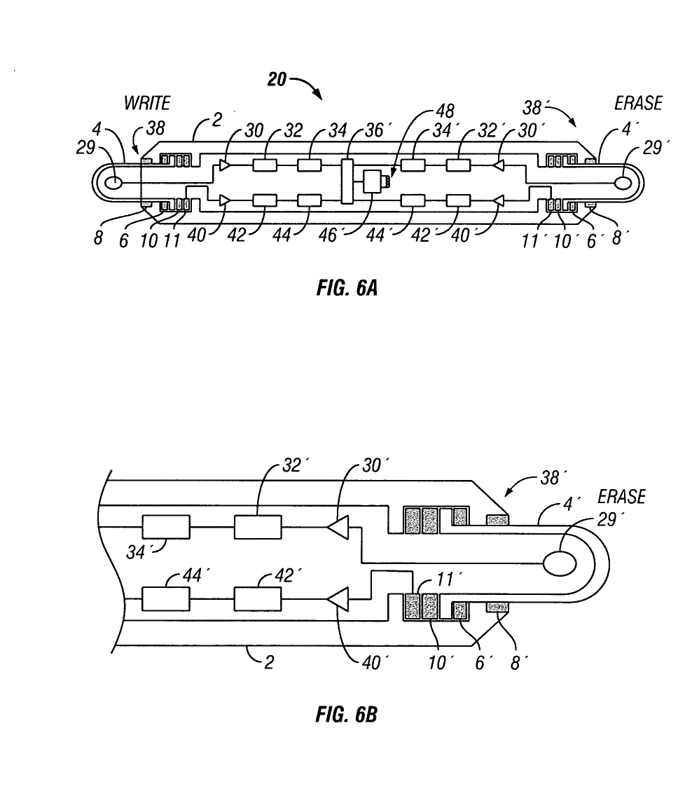

In the present invention, data entry by the user into the seismic data processing program may be performed using a graphic digitizing display tablet and associated stylus. One such display is sold under the trademark CINTIQ, which is a registered trademark of Wacom Company, Ltd. Nishi-Shinjuku KF Bldg., 4th Floor 8-14-24 Nishi-Shinjuku Shinjuku-Ku, Tokyo, Japan 160-0023. Operation of an example digitizing display tablet that may be used with a computer having an interpretation program thereon will now be explained with reference to FIGS. 5A, 5B, 6A and 6B. The description that follows is only one example of a digitizing display tablet and stylus that can be used to perform a method according to the invention.

FIG. 5B shows an overall system block diagram of a computer-based seismic interpretation system that includes a digitizing display tablet 22 and stylus 20. Such system can include a programmable computer or workstation 74. The computer 74 can include a memory, which may be a random access memory or other computer readable storage medium, coupled by a system bus to a central processing unit (“CPU”), a keyboard, a separate display monitor, a disk drive or similar bulk data storage device, a local area network (“LAN”) adapter. The memory in the computer 74 stores an operating system program, device driver programs and application programs which are sequences of executable instructions that are executed in the computer's CPU. In the present embodiment, a seismic data interpretation program, for example, as explained above with reference to FIGS. 1 through 4 may be stored and used as one of the application programs. The LAN adapter of the computer 74 can connect to a local area network (“LAN”) that can connect the computer 74 to other computers and other networks. The stylus 20 can communicate with the digitizing display tablet 22 by means of an electromagnetic link that can be frequency modulated radio signals, amplitude modulated radio signals, or modulated optical or infrared radiation signals. One such communication architecture will be explained in more detail below with reference to FIG. 5A. The digitizing display tablet 22 may include an embedded liquid crystal display (“LCD”) (not shown separately) that displays the same or different data than are displayed on the computer display. Preferably, the application program (seismic interpretation program) is configured to display seismic data for interpretation on the LCD (not shown).

FIG. 5A is a block diagram of overall architecture for data and control signal communication between the stylus 20 and the digitizing display tablet 22. The digitizing tablet 22 and stylus 20 which are described herein are explained in greater detail in U.S. Pat. No. 5,475,401 issued to Verrier et al., incorporated herein by reference.

The stylus 20 can include a mechanical contact detecting circuit 24 consisting of a tablet contact detector 38, signal amplifier 40, pressure detector 42 and analog to digital converter 44. The mechanical contact detecting circuit 24 shown in FIG. 5A is generally disposed on one end of the stylus 20 and constitutes the “write” end of the stylus 20. The write end of the stylus 20 is placed into contact with the tablet 22 when the user intends to enter data into the program. As will be explained further with reference to FIGS. 6A and 6B, circuitry that is substantially identical to the tablet contact detector 38 may be disposed in the other end of the stylus 20. Such circuitry forms part of the “erase” end of the stylus 20. The user may delete data from the program by placing the erase end in contact with the tablet 22, as will be further explained below.

The stylus 20 may also include a position detecting circuit 26. The mechanical contact detecting circuit 24 generates a signal when either end of the stylus 20 is in contact with the surface of an electrostatic screen 54 forming part of the display tablet 22. As will be further explained, such signal may be non-zero to indicate contact, and zero to indicate lack of such contact. In other embodiments, a magnitude of the signal generated by the mechanical contact detecting circuit 24 may be related to an amount of contact pressure between the stylus 20 and the tablet 22. The position detecting circuit 26 generates signals corresponding to the coordinate position of the stylus 20 with respect to the surface of an electrostatic screen 54 forming part of the tablet 22 when either end of the stylus 20 is in contact with the table 22. The position detecting circuit 26 shown in FIG. 5A is for the write end of the stylus 20, as explained above. Substantially identical circuitry may be disposed in the erase end of the stylus 20.

The mechanical contact detecting circuit 24 includes, as explained above, a tablet contact detector 38. The tablet contact detector 38 can be connected to the signal amplifier 40, which has its output connected to pressure detector circuitry 42. The output of the pressure detector circuitry 42 can be coupled to a first analog-to-digital converter (“ADC”) 44. The first ADC 44 outputs numbers representing the pressure applied to the front surface of the electrostatic screen 54. The output of the first ADC 44 is then applied to a first input of a multiplexer 36 for formatting into data signals to be communicated to the tablet 22. How the data signals are communicated will be further explained below.

The position detecting circuit 26 includes a position detecting antenna 29 that detects electromagnetic signals emitted from radiating electrodes 56, 58 embedded in the electrostatic screen 54. Electrostatic screen driver circuits 60 provide such signals to the electrodes 56, 58, and when the signals are detected they correspond to the coordinate position of the stylus 20 on the face of the electrostatic screen 54. Typically, the electrodes 56, 58 are arranged in a generally rectangular grid, and each electrode 56, 58 has a distinct signal radiated therefrom. The signal radiated by each electrode 56, 58 may be made distinct by having a unique amplitude, frequency, phase or other distinguishing characteristic. Thus, the radiated signals will have a distinct pair of signal characteristics associated with each intersection of the electrodes 56, 58 in the grid. In the present embodiment, the distinguishing feature may be amplitude. The position detecting antenna 29 is coupled to a signal strength detector 32 to determine the signal amplitude and thus identify the stylus position. The signal strength detector is coupled to a second ADC 34. The output of the second ADC 34 is coupled to another input of the multiplexer 36.

Position information detected by the position detecting antenna 29, as well as contact pressure information generated by the tablet contact detecting circuit 24, may be communicated to the tablet 22 by transmitting output of the multiplexer 36 through a frequency shift keying (FSK) transmitter 46, which is coupled at its output through a transmit/receive switch 50 to a stylus data antenna 48 in the stylus 20. The signals transmitted through the stylus data antenna 48 are detected by a tablet data antenna 62 in the tablet 22.

Control signals may be generated in a microprocessor 68 in the tablet 22. For example, signals used to select in which order or format the data signals are passed through the multiplexer 36, may be detected in the stylus data antenna 48 through a FSK receiver 52 coupled to the stylus data antenna 48 through the switch 50. Such control signals may be conducted to a FSK control transmitter 70, amplified in an amplifier 72, and conducted to the tablet data antenna 62. Data signals related to contact pressure on the stylus 20 and position of the stylus 20 with respect to the screen 54 may be detected in the tablet data antenna 62 and conducted to the microprocessor 68 for transmission to the CPU (FIG. 5B) in the form of graphic data entry (or deletion) signals as would ordinarily be input to the CPU from a mouse or similar graphic user interface device.

Referring to FIG. 6A, the stylus 20 and in particular, the details of the tablet contact detector 38 will now be explained. The tablet contact detector 38 includes a pressure transducer 10 having a layer formed of a force sensitive resistant (“FSR”) transducer material, for example, a material manufactured by Interlink Electronics, Santa Barbara, Calif. Such FSR material changes its resistance when compressed by the application of a force on its surface. Electrically conductive electrodes on a printed circuit board 11 contact separated portions of the surface of the FSR transducer 10 such that a complete circuit is formed between the conductors on the printed circuit board 11 by way of the pressure transducer 10. The electrodes on the printed circuit board 11 are pressed against the transducer 10 to complete the electrical circuit.

When the signal amplifier 40 (shown in FIG. 5A) is turned on, but the stylus 20 is not yet in use, a voltage will be applied across the transducer 10 by way of the stylus terminals and conductive electrodes 11. When the tip 4 of the stylus 20 is pressed against the electrostatic screen surface (54 in FIG. 5A), the transducer 10 is compressed between the surfaces of two opposing parts. The first opposing part is the stylus tip 4, which is slightly displaced when pressure is exerted on the stylus tip 4. Motion of the tip 4 is limited by a bushing 8, and the interior of the stylus may be sealed by a gasket 6. The other opposing part is the printed circuit board 11, which is held in place in a housing 2 (as shown in FIG. 6B). When the transducer 10 is compressed, its electrical resistance changes such that a current and/or voltage change is produced at the output connected to the signal amplifier 40. The change in current or voltage is used to initiate acquisition of contact pressure data.

Also included within the tip 4, which may be hollow, is the position detecting antenna 29, which is in electromagnetic communication with the radiating electrodes (56 and 58 in FIG. 5A) disposed in the electrostatic screen (54 in FIG. 5A). The position detecting antenna 29 detects electromagnetic signals radiated from the electrodes (56 and 58 in FIG. 5A) in the electrostatic screen (54 in FIG. 5A), which as explained earlier have characteristics that correspond to the coordinate position on the screen (54 in FIG. 5A). The output of the position detecting antenna 29 is coupled through an amplifier 30 to a signal strength detector 32. The output of the signal strength detector 32 is then applied to a second analog-to-digital converter (“ADC”) 34. The output of the second ADC 34 is a digital representation of the signal strength detected by the position detecting antenna 29 of the signals radiated from the radiating electrodes (56 and 58 in FIG. 5A) in the electrostatic screen (54 in FIG. 5A).

The second ADC 34 in turn outputs a digital representation of the relative position of the stylus 20 with respect to the electrostatic screen 54, as a number or numbers, to a second input to the multiplexer 36.

The multiplexer 36 can be controlled to change the order and content of the data stream. A multiplexed data stream of numbers representing the output of the pressure detector (first) ADC 44 and the position detecting (second) ADC 34 are applied to the frequency shift key (“FSK”) transmitter 46. The output of the FSK transmitter 46 is then applied to the stylus data antenna 48. The stylus data antenna 48 then radiates the data signals, which include the applied pressure on the tablet contact detector 38 and the position information detected by the position detecting antenna 29. The data signals are detected by the tablet data antenna (62 in FIG. 5A). The detected data signals may be amplified in an amplifier (64 in FIG. 5A), decoded in a FSK receiver (65 in FIG. 5A) and conducted to the microprocessor (68 in FIG. 5A) for conversion to mouse-equivalent output for the computer (74 in FIG. 5B).

The foregoing components of the stylus shown in FIG. 5A and FIG. 6A are for the “write” end of the stylus 20. When the write end of the stylus 20 is placed in contact with the screen (54 in FIG. 5A), the signal from the tablet contact detector circuit 38 becomes non-zero as explained above. The computer program is typically configured to begin accepting input data related to the position of the stylus (as detected by the position detecting circuit 26) for all times when the tablet contact signal is non-zero. Thus, the user may “draw” with the stylus 20 by maintaining contact between the stylus 20 and the screen (54 in FIG. 5A) while moving the stylus 20 over the screen in a user-selected manner. In interpreting seismic data according to the invention, the seismic data may be displayed on the electrostatic screen (54 in FIG. 5A) in a manner such as shown in FIGS. 1 through 4. The user may move the stylus 20 over features observed in the displayed seismic data while maintaining contact with the screen (54 in FIG. 5A), for example, a visually interpreted horizon. All positions of the stylus 20 during such contact are thus entered into the computer program as user-provided data input.

In the present embodiment, the stylus may include an “erase” end. The erase end of the stylus 20 may be used when the user desires to delete previously entered user-provided input data or other data susceptible to deletion from the interpretation program by the user. The erase end of the stylus includes components, as explained above, that correspond to those in the write end of the stylus 20. Such components include a tip 4′, bushing 6′, gasket 8′, pressure transducer 10′, circuit board 11′, signal amplifiers 30′, 40′, signal strength detector 32′, first ADC 44′ and second ADC 34′. The functions of the foregoing components is essentially identical to those described above with reference to the write end of the stylus. Output of the erase end ADCs 34′ and 44′ can be coupled to the same multiplexer 36, and ultimately transmitted to the digitizing display tablet (22 in FIG. 5A) by the FSK transmitter 46 through the data antenna 48.

A side cross-section in FIG. 6B provides a more detailed illustration of the mechanical and electrical parts for the erase end of the stylus 20. The foregoing circuits in the erase end of the stylus 20 are designed to generate a non-zero pressure signal when the erase tip 4′ is in mechanical contact with the electrostatic tablet (54 in FIG. 5A), and to generate a zero signal when neither tip is in such mechanical contact. Such signals are used to cause the position of the erase tip 4′ of the stylus 20, determined as explained above for the write end, to be deleted as data when the erase end tablet contact signal is non-zero. Thus, the user may “erase” entered data in the form of interpreted horizons, for example, by maintaining contact between the erase tip 4′ and the electrostatic screen (54 in FIG. 5A), and moving the stylus 20 along the feature to be erased. As will be appreciated by those skilled in the art, data may be entered and/or deleted as discrete points by making corresponding point contact between the stylus 20 and the screen (54 in FIG. 5A).

Referring once again to FIG. 6A, in some embodiments, the contact detecting circuit in the erase end, as well as the write end, can also output signals corresponding to several levels of pressure. For example, the contact detecting circuits 38, 38′ can output sixteen discrete levels each represented by four binary bits, corresponding to sixteen discrete levels of pressure applied to the screen (54 in FIG. 5A) by either tip 4, 4′. Such contact pressure resolution is made possible by detecting changes in resistance of the transducers 10, 10′. Such changes in resistance change the signal output of each amplifier 40, 40′, which results in a different number being output from the corresponding ADCs 42, 42′. Having different, identifiable levels of pressure can be used for applications such as shading, multiple or wide lines, etc. Alternatively, the discrete pressure levels may alter a characteristic of the user-entered data such that the user may uniquely identify the entered data. One example of such identification is to characterize individually interpreted seismic horizons by an associated distinct display color. The microprocessor (68 in FIG. 5A) may be configured to generate a unique color driver signal for each of the discrete pressure levels, thus enabling the user to identify separate features in the interpreted seismic data by color.

Embodiments of a method according to the present invention may improve the ease and accuracy with which a user may input data to a seismic data processing program.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for interpreting seismic data, comprising:
displaying seismic data on a graphic digitizing tablet; and
entering at least one data point to a seismic data interpretation program by contacting a write end of a digitizing stylus to the digitizing tablet at a user-selected position within the displayed seismic data.

2. The method of claim 1 further comprising entering a plurality of data points into the program corresponding to at least one feature in the seismic data by maintaining contact between the write end of the stylus and the tablet and moving the stylus along the feature.

3. The method of claim 1 further comprising deleting at least one data point from the seismic interpretation program by contacting an erase end of the stylus to the digitizing tablet at a user-selected position within the displayed seismic data.

4. The method of claim 1 further comprising deleting a plurality of data points from the program corresponding to at least one feature in the seismic data by maintaining contact between the erase end of the stylus and the tablet and moving the stylus along the feature.

5. The method of claim 1 further comprising adjusting a line width of data entered into the interpretation program by adjusting a contact pressure between the stylus and the digitizing tablet.

6. The program of claim 1 further comprising adjusting a contact pressure between the stylus and the tablet to relate a user-selected characteristic to the at least one data point.

7. The program of claim 6 wherein the user-selected characteristic comprises at least one of line width and display color.
